(19) United States
(12) Patent Application Publication
(10) Pub. No.: US 2017/0357931 A1
(43) Pub. Date: Dec. 14, 2017

(54) SMART CALENDARING - EVENT PROXIMITY CONFLICT IDENTIFICATION

(71) Applicant: International Business Machines Corporation, Armonk, NY (US)

(72) Inventors: Rhonda L. Childress, Austin, TX (US); Kim A. Eckert, Austin, TX (US); Ryan D. McNair, Austin, TX (US); Minh Q. Pham, Austin, TX (US)

(21) Appl. No.: 15/176,648

(22) Filed: Jun. 8, 2016

(51) Int. Cl. G06Q 10/06; G06F 17/30; G06Q 10/10

(52) U.S. Cl. CPC G06Q 10/063116; G06Q 10/06314; G06Q 10/1095; G06F 17/30864

(57) ABSTRACT

An approach, for calendaring event proximity conflict identification. An event conflict identifier receives an instruction to add a second calendar event to a user calendar. The event conflict identifier, identifies location proximity conflicts based on searching calendar metadata associated with the user calendar, where the calendar metadata includes first geographic locations associated with first calendar events. The event conflict identifier responds by creating event conflict alerts including conflict resolution action options associated with the location proximity conflicts respectively and outputting the event conflict alerts.

### BACKGROUND OF THE INVENTION

The present invention relates generally to the field of calendaring systems and more particularly to, identifying calendar event conflict based on user geographic proximity.

Calendaring systems can be considered a core component of personal information management. The typical calendaring application minimally provides a mechanism for scheduling an event to occur on a certain date at a certain time. Calendaring systems permit users to keep track of their personal and professional schedules, so that they do not miss appointments and/or events. A user can participate in appointments and/or events both in-person and virtually (e.g., teleconferencing, video conferencing). When a user receives an invitation to attend an event in-person and/or a travel event (e.g., international business trip) is added to a calendar, it can become important to check existing calendar events for geographic location conflicts that can prevent participation and identify conflicts needing resolution action.

### SUMMARY

As disclosed herein, a method, for calendaring event proximity conflict identification, the method comprising: receiving, by event conflict identifier, an instruction to add a second calendar event to a user calendar; identifying, by the event conflict identifier, one or more location proximity conflicts based on searching one or more calendar metadata associated with the user calendar, wherein the one or more calendar metadata comprises one or more first geographic locations associated with one or more first calendar events; responsive to identifying the one or more location proximity conflicts, creating, by the event conflict identifier, one or more event conflict alerts comprising one or more conflict resolution action options associated with the one or more location proximity conflicts respectively and outputting, by the event conflict identifier, the one or more event conflict alerts. A computer system and a computer program product corresponding to the above method are also disclosed herein.

### BRIEF DESCRIPTION OF THE DRAWINGS

FIG. 1 illustrates a functional block diagram of a computing environment, in accordance with an embodiment of the present invention;

FIG. 2 illustrates a flowchart of calendaring event location proximity conflict identification, in accordance with an embodiment of the present invention;

FIG. 3 illustrates examples of calendar event conflict processing scenarios, in accordance with an embodiment of the present invention; and

FIG. 4 illustrates a block diagram of components of the server and/or the computing device, in accordance with an embodiment of the present invention.

### DETAILED DESCRIPTION

Embodiments of the present invention can create, manage and search location based metadata in a calendaring system to determine and alert a user of existing user calendar events that conflict based on proximity of a received calendar event. When comparing geographic locations of calendar events of a user with a received event near a similar time slot, an alert can be output to indicate that geographic proximately of the event can inhibit planned event participation (e.g., location proximity conflict). For example, a new meeting can be received that is scheduled in a city, sixty miles from an existing preceding meeting. An alert can be output to indicate that the user cannot physically travel to the new meeting if there is not enough time between meetings and the user plans to physically participate/attend the former meeting. A user can resolve location proximity conflicts by taking actions such as, but not limited to, cancel an event, reschedule an event, ignore a conflict, assign a delegate, choose alternate teleconference attendance and defer conflict resolution decision.

Embodiments of the present invention will now be described in detail with reference to the figures. It should be noted that references in the specification to “an exemplary embodiment,” “other embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure or characteristic is described in connection with an embodiment, it is submitted that it is within the knowledge of one skilled in the art to affect such feature, structure or characteristic in connection with other embodiments whether or not explicitly described.

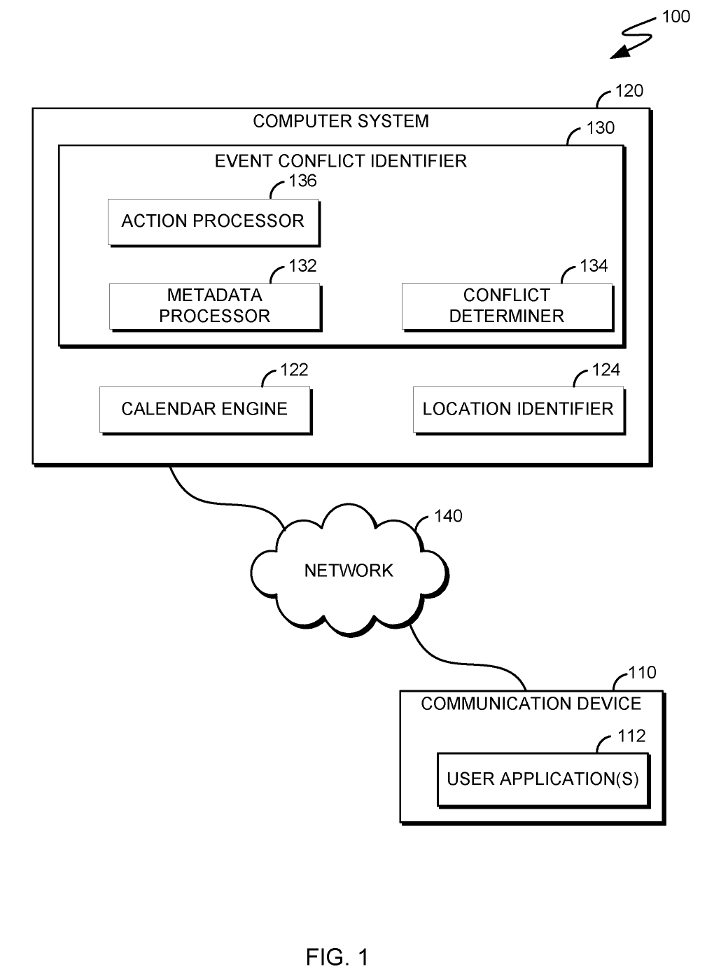

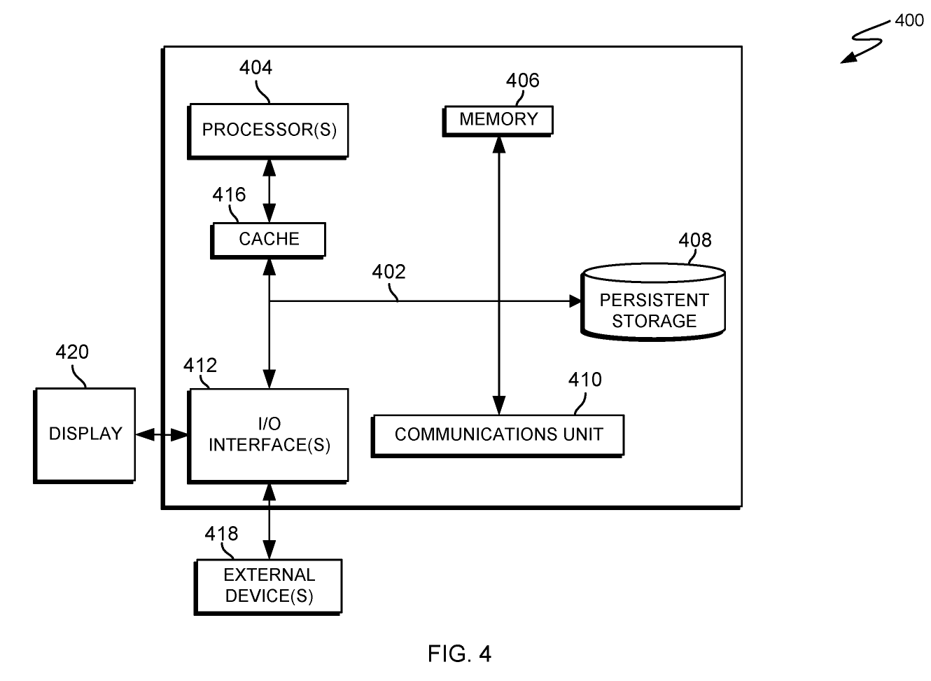

FIG. 1 illustrates a functional block diagram of a computing environment, in accordance with an embodiment of the present invention. Computing environment 100 comprises COMMUNICATION DEVICE 110, and COMPUTER SYSTEM 120, interconnected via NETWORK 140. COMMUNICATION DEVICE 110 and COMPUTER SYSTEM 120 can be desktop computers, laptop computers, specialized computer servers, or the like. In certain embodiments, COMMUNICATION DEVICE 110 and COMPUTER SYSTEM 120 represent computer systems utilizing clustered computers and components acting as a single pool of seamless resources via NETWORK 140. For example, such embodiments can be used in data center, cloud computing, storage area network (SAN), and network attached storage (NAS) applications. In general, COMMUNICATION DEVICE 110 and COMPUTER SYSTEM 120 are representative of any electronic devices, or combination of electronic devices, capable of executing computer readable program instructions, as described in detail with regard to FIG. 4.

In one embodiment of the present invention, COMMUNICATION DEVICE 110 comprises USER APPLICATION(S) 112. USER APPLICATION(S) 112 can be a plurality of USER APPLICATION(S) 112 within COMMUNICATION DEVICE 110.

USER APPLICATION(S) 112 can be an application used to manage one or more calendaring systems and can be an interfacing tool toward CALENDAR ENGINE 122 and/or EVENT CONFLICT IDENTIFIER 130. In embodiments of the present invention, USER APPLICATION(S) 112 comprises any combination of commercial or custom devices and/or software products associated with operating and maintaining electronic calendar(s).

NETWORK 140 can be, for example, a local area network (LAN), a wide area network (WAN) such as, the Internet, or a combination of the two, and include wired, wireless, or fiber optic connections. In general, NETWORK 140 can be any combination of connections and protocols that will support communications between COMMUNICATION DEVICE 110 and COMPUTER SYSTEM 120, in accordance with an embodiment of the present invention.

In one embodiment of the present invention, COMPUTER SYSTEM 120 comprises CALENDAR ENGINE 122, LOCATION IDENTIFIER 124 and EVENT CONFLICT IDENTIFIER 130.

In one embodiment of the present invention, CALENDAR ENGINE 122 can be a plurality of CALENDAR ENGINES 122 within COMPUTER SYSTEM 120. CALENDAR ENGINE 122 can provide users with an electronic version of a calendar used for managing and/or scheduling events of a user. Further, each calendar event can comprise metadata (e.g., data about data) that can be accessed and/or updated by EVENT CONFLICT IDENTIFIER 130. In embodiments of the present invention, CALENDAR ENGINE 122 can comprise any combination of commercial or custom devices and/or software products associated with electronic calendaring.

In one embodiment of the present invention, LOCATION IDENTIFIER 124 can be a plurality of LOCATION IDENTIFIERS 124 within COMPUTER SYSTEM 120. LOCATION IDENTIFIER 124 can receive a plurality of location attributes such as, but not limited to, city, state, country, Global Positioning System (GPS) location and business name to output a mapping position of a location. In embodiments of the present invention, LOCATION IDENTIFIER 124 can comprise any combination of commercial or custom devices and/or software products associated with identifying a physical event location. For example, LOCATION IDENTIFIER 124 can comprise an information source such as, but not limited to, Google Maps by Google Inc. and user accessible private and/or public address books. LOCATION IDENTIFIER 124 can determine an event location and calculate distance (e.g., proximity) by location comparison of a plurality of events. When LOCATION IDENTIFIER 124 completes operation, output can be sent toward CONFLICT DETERMINER 134.

In one embodiment of the present invention, EVENT CONFLICT IDENTIFIER 130 can be a plurality of EVENT CONFLICT IDENTIFIERS 130 within COMPUTER SYSTEM 120 and EVENT CONFLICT IDENTIFIER 130 can be a separate and/or integrated tool that can be operated during calendaring event management (e.g., CALENDAR ENGINE 122) to determine and alert users of event physical location proximity conflicts. EVENT CONFLICT IDENTIFIER 130 can comprise METADATA PROCESSOR 132, CONFLICT DETERMINER 134 and ACTION PROCESSOR 136. In embodiments of the present invention, EVENT CONFLICT IDENTIFIER 130 can comprise any combination of commercial or custom devices and/or software products associated with identifying physical event location proximity conflicts.

In one embodiment of the present invention, METADATA PROCESSOR 132 can be a plurality of METADATA PROCESSORS 132 within EVENT CONFLICT IDENTIFIER 130. METADATA PROCESSOR 132 can receive a calendar event from CALENDAR ENGINE 122 and/or USER APPLICATION(S) 112 and if the calendar event comprises a physical location, METADATA PROCESSOR 132 can send data toward LOCATION IDENTIFIER 124 to determine an identifiable location of the event. Further, metadata such as, but not limited to, cancellation policy and conflict resolution decision information can be collected and processed by METADATA PROCESSOR 132. When METADATA PROCESSOR 132 completes processing, metadata such as, but not limited to, identified location, cancellation policy and conflict resolution decision(s) can be sent toward associated calendar event(s) (e.g., CALENDAR ENGINE 122).

In one embodiment of the present invention, CONFLICT DETERMINER 134 can be a plurality of CONFLICT DETERMINERS 134 within EVENT CONFLICT IDENTIFIER 130. CONFLICT DETERMINER 134 can search calendar events comprising geographic location metadata in a predetermined time period, in response to receiving a calendar event from CALENDAR ENGINE 122 and/or USER APPLICATION(S) 112. For example, a received one hour event can be added to a calendar and a work day time period can be searched to determine if any events in the day are in close geopraphic proximity and if not, then a conflict could be determined. In another example, a received calendar event could be a travel event such as, but not limited to, an airplane flight. In this example, the duration of the flight can establish the time period for a conflict search. In embodiments of the present invention, CONFLICT DETERMINER 134 can comprise any combination of commercial or custom devices and/or software products associated with receiving calendar event metadata (e.g., CALENDAR ENGINE 122) and/or location identifiers (e.g., LOCATION IDENTIFIER 124) to determine proximity between event locations. It should be noted that determination of proximity can be based on a predetermined threshold comprising distance and travel time. For example, two meetings in a single day may be located in two cities that are fifteen miles apart. With an example threshold proximity of thirty miles/thirty-five minutes travel time and assuming there are sixty minutes between meetings, a conflict may not exist. If two cities are sixty miles apart with the aforementioned threshold, a conflict can be identified. It should be further noted that proximity can received from LOCATION IDENTIFIER 124 with distance/time adjustments based on predetermined factors such as, but not limited to, mode of travel, time of day and detours. When CONFLICT DETERMINER 134 identifies location proximity conflict(s), associated event and/or location information can be sent toward ACTION PROCESSOR 136.

In one embodiment of the present invention, ACTION PROCESSOR 136 can be a plurality of ACTION PROCESSORS 136 within EVENT CONFLICT IDENTIFIER 130. ACTION PROCESSOR 136 can receive event location proximity conflict from CONFLICT DETERMINER 134 to output user alerts related to location proximity conflict(s) of user calendar events. In embodiments of the present invention, ACTION PROCESSOR 136 can comprise any combination of commercial or custom devices and/or software products associated with processing calendar event conflict notifications. When ACTION PROCESSOR 136 completes, alert notification(s) can be sent toward COMMUNICATION DEVICE 110.

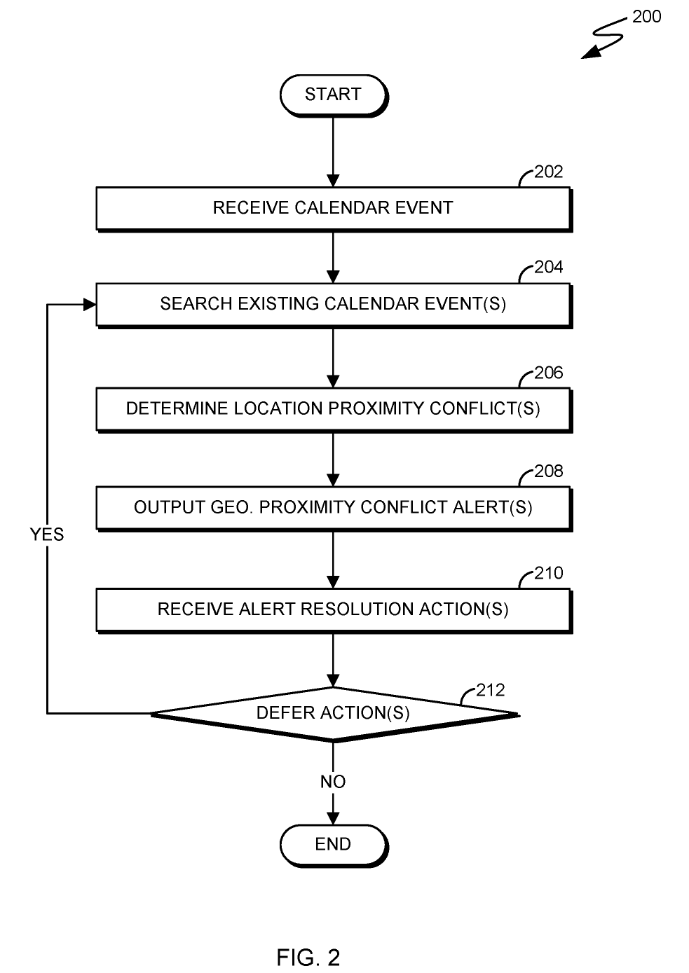

FIG. 2 illustrates a flowchart of calendaring event location proximity conflict identification, in accordance with an embodiment of the present invention. Event conflict identifier 200, comprises operations RECEIVE CALENDAR EVENT 202, SEARCH EXISTING CALENDAR EVENT(S) 204, DETERMINE LOCATION PROXIMITY CONFLICT(S) 206, OUTPUT GEO. PROXIMITY CONFLICT ALERT(S) 208, RECEIVE ALERT RESOLUTION ACTION(S) 210 and DEFER ACTION(S) 212.

Operation RECEIVE CALENDAR EVENT 202, can receive a calendar event (e.g., second calendar event) to add to user calendar and/or to search for geographic location conflicts. Execution of operation RECEIVE CALENDAR EVENT 202 can be initiated by events such as, but not limited to, a new event, changed/reschedule event, user interaction, periodic refresh and expiration of deferred conflict resolution action. It should be noted that a received calendar event can be identified as physical participation events as compared to remote participation events (e.g., teleconference event) to enable event conflict identification toward physical participation events.

Operation SEARCH EXISTING CALENDAR EVENT(S) 204, can search existing event metadata for a predetermined range of events (e.g., first calendar event) to find identified geographic location events where a user is scheduled to participate. For example, a single one-hour event received from operation RECEIVE CALENDAR EVENT 202 can initiate a search within a single day whereas a received travel event (e.g., flight reservation) can initiate a search of calendar events during the departing flight duration, the time span proceeding the departing flight arrival (e.g., duration away from ‘home’ location) and the duration of the return flight. In the case of an event type such as, but not limited to, a travel event, the range of calendar event searched can be bound by a next geographic location event (e.g., a next travel event). For example, a user can have a series of travel events before returning a ‘home’ location. In this case each next travel event (e.g., travel segment) can delimit a search of location proximity conflicts. As geographic location events are found, operation SEARCH EXISTING CALENDAR EVENT(S) 204 can send results toward operation DETERMINE LOCATION PROXIMITY CONFLICT(S) 206. It should be noted that each geographic location event can be sent individually and/or collectively toward operation DETERMINE LOCATION PROXIMITY CONFLICT(S) 206. Execution of operation SEARCH EXISTING CALENDAR EVENT(S) 204 can be initiated actions such as, but not limited to, by operation RECEIVE CALENDAR EVENT 202, timed actions (e.g., delay duration), scheduled actions (e.g., time of day), programmed actions (e.g., logical operation) and interactive actions (e.g., user action).

Operation DETERMINE LOCATION PROXIMITY CONFLICT(S) 206, can determine if a received calendar event (e.g., second calendar event) comprises geographic proximity beyond a predetermined threshold value. Operation DETERMINE LOCATION PROXIMITY CONFLICT(S) 206 can send a received second calendar event toward LOCATION IDENTIFIER 124 to determine identification of the event location. Operation DETERMINE LOCATION PROXIMITY CONFLICT(S) 206 can also send each first calendar event(s) (e.g., received from operation SEARCH EXISTING CALENDAR EVENT(S) 204) toward LOCATION IDENTIFIER 124 to compare location identifications of the second calendar event location with the first calendar location(s) to determine geographic proximity. Where geographic proximity of each associated calendar events exceeds a predetermined threshold, a location proximity conflict is identified. As location proximity conflict(s) are identified, operation DETERMINE LOCATION PROXIMITY CONFLICT(S) 206 can send location proximity conflict results toward operation OUTPUT GEO. PROXIMITY CONFLICT ALERT(S) 208.

Operation OUTPUT GEO. PROXIMITY CONFLICT ALERT(S) 208, can output alerts toward a user, based on each identified location proximity conflict. For each location proximity conflict, suggested resolution action(s) can be output for user selection. Resolutions such as, but not limited to, cancelling, rescheduling, ignoring, assigning a delegate, choose teleconference attendance mode and defer conflict resolution decision can be output based on predetermined user preferences and/or calendar event metadata settings.

Operation RECEIVE ALERT RESOLUTION ACTION(S) 210, can receive user response(s) (e.g., selections) to conflict alert(s). Operation OUTPUT GEO. PROXIMITY CONFLICT ALERT(S) 208 can send conflict resolution actions toward associated metadata (e.g., CALENDAR ENGINE 122) to store location proximity conflict action(s) that can be analyzed in subsequent event conflict identifier 200 operation. It should be noted that a defer action can establish follow-up date(s)/time(s) to output repeated event conflict alert(s). It should be further noted that a defer action could record received information such as, but not limited to, event cancellation date/time attribute(s) where an event conflict alert could be output based on follow-up timing associated to metadata attribute(s) (e.g., avoiding change/cancellation fees associated to an event). It should be noted that output of geographic proximity alerts and receiving alert resolution actions can be performed by various methods such as, but not limited to, real-time user interactivity and form based processing.

In decision operation DEFER ACTION(S) 212, if a user decision received from operation RECEIVE ALERT RESOLUTION ACTION(S) 210 is a defer action for an event conflict alert, flow toward operation SEARCH EXISTING CALENDAR EVENT(S) 204 can proceed when associated event metadata deferral date/time is reached. Processing of the deferred conflict resolution decision event can then be re-analyzed to determine further location proximity conflict(s). It should be noted that a received defer action can output a warning/error message toward the user to indicate scheduling flexibility conflicts and/or limited deferral capability based on exceeding predetermined time based threshold rules in comparison of related date/time metadata such as, but not limited to, a calendar event cancellation policy. For example, a hotel reservation can have a policy to cancel by five PM in the destination time zone and a defer action of a conflicting event can cause a warning that a hotel reservation needs to be cancelled by a specific date in a user's time zone to avoid penalty. In the example, a deferral date/time (e.g., follow-up) setting can be limited based on, but not limited to, a date/time that will avoid cancellation penalty. When decision operation DEFER ACTION(S) 212 is false, flow execution ends until an initiating event activates operation RECEIVE CALENDAR EVENT 202.

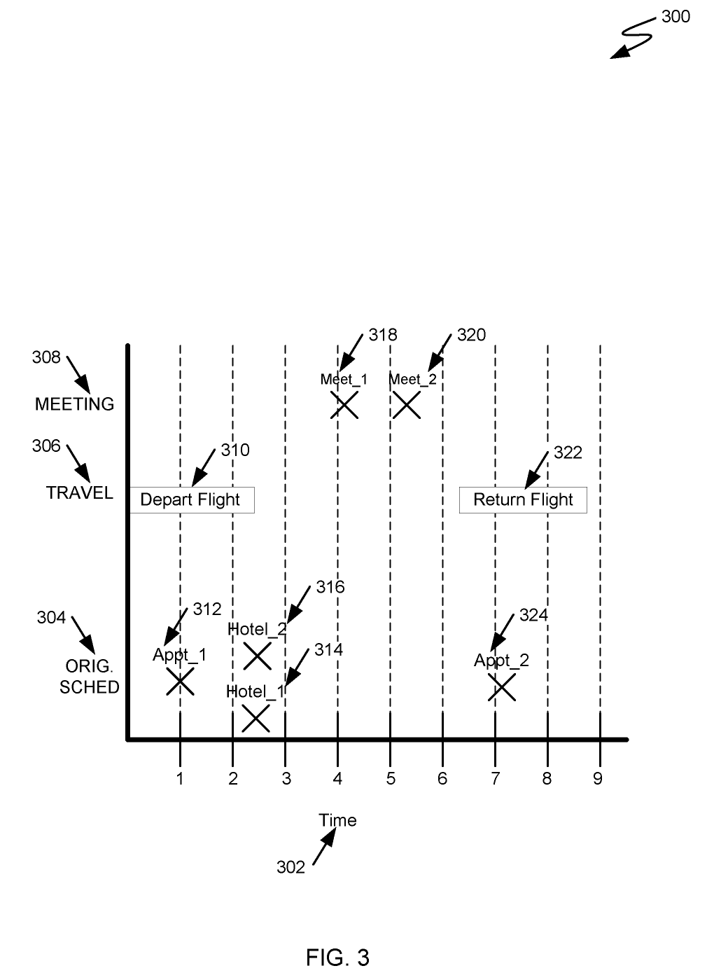

FIG. 3 illustrates examples of calendar event conflict processing scenarios, in accordance with an embodiment of the present invention. The location proximity conflict processing scenarios 300 represents samples of received events that can be processed with respect to a user calendar. Location proximity conflict processing scenarios 300 can comprise items Time 302, ORIG. SCHED 304, TRAVEL 306, MEETING 308, Depart Flight 310, Appt_1 312, Hotel_1 314, Hotel_2 316, Meet_1 318, Meet_2 320, Return Flight 322 and Appt_2 324.

Item Time 302 can represent a scale of time 1 through 9, depicted as a normalized unit of measure which can comprise units such as, but not limited to, date and time (e.g., day, hour, minute, etc.).

Item ORIG. SCHED 304 can represent a user original schedule of calendar events for comparison to received events, indicated by item TRAVEL 306 and item MEETING 308.

Item Depart Flight 310 illustrates a received event of a departing flight from a user ‘home’ location. Item Depart Flight 310 is represented as a bar, to indicate a duration that the flight consumes on a calendar. Item Appt_1 312, can be an appointment conflicting with item Depart Flight 310 based on a location proximity conflict. An alert can be sent toward the user where the user may need to cancel item Appt_1 312.

Noting that item Return Flight 322 is located near item Time 302, value 6, it can be shown that item Appt_2 324, appointment 2, can also be identified as a location proximity conflict. However, in this example, item Appt_2 324 can be an appointment for the user's child. In this case, an alert would be output and the user could choose to delegate the appointment to another caregiver (e.g., spouse). In this example, the conflict is resolved by removing the conflict from the user calendar without cancelling the event.

When analyzing the time span between item Depart Flight 310 and item Return Flight 322, item Hotel_1 314, hotel reservation 1, can be for the geographic location of item Depart Flight 310 destination location. Metadata of item Depart Flight 310 event and item Hotel_1 314 can be used to determine that no location proximity conflict exists as the user is in a new ‘home’ location.

Item Hotel_2 316 can be a second hotel reservation in item Depart Flight 310 destination location and the reservation is made for relatives joining the user in a trip. Since item Hotel_1 314 and item Hotel_2 316 are in the same geographic location, a location proximity conflict can cause an event conflict alert, as one of the hotel reservations may be a duplicate. In this case, the user can respond to an event conflict alert by deferring a decision to cancel the second reservation to allow time to confirm that the relatives are going to join the travel. It should be noted in some embodiments of the present invention that the user could enter cancellation policy rules (e.g., stored in event metadata) for the hotel so that the deferral of conflict resolution can output another event conflict alert in time to cancel the hotel without penalty.

Item Meet_1 318 can be business meeting associated to the user's home location, however an alternative teleconference number may be provided with the meeting notice. In this example, an event conflict alert can be output and the user can make a determination to participate via teleconference.

Item Meet_2 320 can be second business meeting in the user's ‘home’ location however the meeting in this example is informational. The user may determine they want to keep the meeting on their calendar, in case the user is able to participate. In this case the user can choose to resolve the associated event conflict alert by responding to the event conflict alert with an ‘ignore’ decision. In this example, event metadata can store the ignore decision to avoid future event conflict alerts.

FIG. 4 illustrates a block diagram of components of COMMUNICATION DEVICE 110 and COMPUTER SYSTEM 120 in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Computer system 400 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as, microprocessors, communications and network processors, etc.), system memory, peripheral devices, and any other hardware components within a system. For example, communications fabric 402 can be implemented with one or more buses.

Computer system 400 includes processors 404, cache 416, memory 406, persistent storage 408, communications unit 410, input/output (I/O) interface(s) 412 and communications fabric 402. Communications fabric 402 provides communications between cache 416, memory 406, persistent storage 408, communications unit 410, and input/output (I/O) interface(s) 412. Communications fabric 402 can be implemented with any architecture designed for passing data and/or control information between processors (such as, microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of processors 404 by holding recently accessed data, and data near recently accessed data, from memory 406.

Program instructions and data used to practice embodiments of the present invention may be stored in persistent storage 408 and in memory 406 for execution by one or more of the respective processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Program instructions and data used to practice embodiments of the present invention may be downloaded to persistent storage 408 through communications unit 410.

I/O interface(s) 412 allows for input and output of data with other devices that may be connected to each computer system. For example, I/O interface 412 may provide a connection to external devices 418 such as, a keyboard, keypad, a touch screen, and/or some other suitable input device. External devices 418 can also include portable computer readable storage media such as, for example, thumb drives, portable optical or magnetic disks, and memory cards. Software and data used to practice embodiments of the present invention can be stored on such portable computer readable storage media and can be loaded onto persistent storage 408 via I/O interface(s) 412. I/O interface(s) 412 also connect to display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as, punch-cards or raised structures in a groove having instructions recorded thereon, and any suitable combination of the foregoing. A computer readable storage medium, as used herein, is not to be construed as being transitory signals per se, such as, radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as, Smalltalk, C++ or the like, and conventional procedural programming languages, such as, the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method, for calendaring event proximity conflict identification, the method comprising:
receiving, by event conflict identifier, an instruction to add a second calendar event to a user calendar;
identifying, by the event conflict identifier, one or more location proximity conflicts based on searching one or more calendar metadata associated with the user calendar, wherein the one or more calendar metadata comprises one or more first geographic locations associated with one or more first calendar events;
responsive to identifying the one or more location proximity conflicts, creating, by the event conflict identifier, one or more event conflict alerts comprising one or more conflict resolution action options associated with the one or more location proximity conflicts respectively; and
outputting, by the event conflict identifier, the one or more event conflict alerts.

2. The method of claim 1, further comprising:
receiving, by the event conflict identifier, one or more event conflict alert resolutions associated with the one or more event conflict alerts wherein the one or more event conflict alert resolutions comprise a selection of at least one of the one or more conflict resolution action options;
creating, by the event conflict identifier, one or more resolution metadata based on the one or more event conflict alert resolutions; and
storing, by the event conflict identifier, the one or more resolution metadata associated with the one or more calendar metadata.

3. The method of claim 1, wherein searching the one or more calendar metadata is based on a search range comprising at least one of a predetermined value, event type and travel event range.

4. The method of claim 1, wherein identifying, by the event conflict identifier, is responsive to at least one of one or more timed actions, one or more scheduled actions, one or more programmed actions and one or more interactive actions.

5. The method of claim 1, wherein the one or more location proximity conflicts are based on one or more predetermined thresholds having at least one of a date, a time and a distance value.

6. The method of claim 2, wherein at least one of one or more timed actions and one or more scheduled actions are created based on at least one of the one or more event conflict alert resolutions.

7. The method of claim 2, wherein at least one of the one or more event conflict alert resolutions can cancel a next one or more event conflict alerts.

8. A computer program product, for calendaring event proximity conflict identification, the computer program product comprising:
one or more computer readable storage media and program instructions stored on the one or more computer readable storage media, the program instructions comprising:
program instructions to, receive, by event conflict identifier, an instruction to add a second calendar event to a user calendar;
program instructions to, identify, by the event conflict identifier, one or more location proximity conflicts based on searching one or more calendar metadata associated with the user calendar, wherein the one or more calendar metadata comprises one or more first geographic locations associated with one or more first calendar events;
program instructions to, respond to identifying the one or more location proximity conflicts, creating, by the event conflict identifier, one or more event conflict alerts comprising one or more conflict resolution action options associated with the one or more location proximity conflicts respectively; and
program instructions to, output, by the event conflict identifier, the one or more event conflict alerts.

9. The computer program product of claim 8, further comprising:
program instructions to, receive, by the event conflict identifier, one or more event conflict alert resolutions associated with the one or more event conflict alerts wherein the one or more event conflict alert resolutions comprise a selection of at least one of the one or more conflict resolution action options;
program instructions to, create, by the event conflict identifier, one or more resolution metadata based on the one or more event conflict alert resolutions; and
program instructions to, store, by the event conflict identifier, the one or more resolution metadata associated with the one or more calendar metadata.

10. The computer program product of claim 8, wherein searching the one or more calendar metadata is based on a search range comprising at least one of a predetermined value, event type and travel event range.

11. The computer program product of claim 8, wherein identify, by the event conflict identifier, is responsive to at least one of one or more timed actions, one or more scheduled actions, one or more programmed actions and one or more interactive actions.

12. The computer program product of claim 8, wherein the one or more location proximity conflicts are based on one or more predetermined thresholds having at least one of a date, a time and a distance value.

13. The computer program product of claim 9, wherein at least one of one or more timed actions and one or more scheduled actions are created based on at least one of the one or more event conflict alert resolutions.

14. The computer program product of claim 9, wherein at least one of the one or more event conflict alert resolutions can cancel a next one or more event conflict alerts.

15. A computer system, for calendaring event proximity conflict identification, the computer system comprising:
one or more computer processors;
one or more computer readable storage media;
program instructions stored on the one or more computer readable storage media for execution by at least one of the one or more computer processors, the program instructions comprising:
program instructions to, receive, by event conflict identifier, an instruction to add a second calendar event to a user calendar;
program instructions to, identify, by the event conflict identifier, one or more location proximity conflicts based on searching one or more calendar metadata associated with the user calendar, wherein the one or more calendar metadata comprises one or more first geographic locations associated with one or more first calendar events;
program instructions to, respond to identifying the one or more location proximity conflicts, creating, by the event conflict identifier, one or more event conflict alerts comprising one or more conflict resolution action options associated with the one or more location proximity conflicts respectively; and
program instructions to, output, by the event conflict identifier, the one or more event conflict alerts.

16. The computer system of claim 15, further comprising:
program instructions to, receive, by the event conflict identifier, one or more event conflict alert resolutions associated with the one or more event conflict alerts wherein the one or more event conflict alert resolutions comprise a selection of at least one of the one or more conflict resolution action options;
program instructions to, create, by the event conflict identifier, one or more resolution metadata based on the one or more event conflict alert resolutions; and
program instructions to, store, by the event conflict identifier, the one or more resolution metadata associated with the one or more calendar metadata.

17. The computer system of claim 15, wherein searching the one or more calendar metadata is based on a search range comprising at least one of a predetermined value, event type and travel event range.

18. The computer system of claim 15, wherein identify, by the event conflict identifier, is responsive to at least one of one or more timed actions, one or more scheduled actions, one or more programmed actions and one or more interactive actions.

19. The computer system of claim 15, wherein the one or more location proximity conflicts are based on one or more predetermined thresholds having at least one of a date, a time and a distance value.

20. The computer system of claim 16, wherein at least one of one or more timed actions and one or more scheduled actions are created based on at least one of the one or more event conflict alert resolutions.
